(19) United States
(12) Patent Application Publication
(10) Pub. No.: US 2025/0140825 A1
(43) Pub. Date: May 1, 2025

(54) CONDUCTIVE MATERIALS MIXTURE AND LAYER FOR MANGANESE RICH CATHODE ELECTRODE

(71) Applicant: FORD GLOBAL TECHNOLOGIES, LLC, Dearborn, MI (US)

(72) Inventors: Jonghwan PARK, Ann Arbor, MI (US); Insik JEON, Novi, MI (US); Wei XU, Livonia, MI (US)

(21) Appl. No.: 18/499,736

(22) Filed: Nov. 1, 2023

(51) Int. Cl. H01M 4/505; H01M 4/02; H01M 4/04; H01M 4/62; H01M 4/66; H01M 10/052

(52) U.S. Cl. CPC H01M 4/505; H01M 4/0404; H01M 4/625; H01M 4/661; H01M 10/052; H01M 2004/021; H01M 2004/028

(57) ABSTRACT

A lithium-ion battery with an enhanced electrode structure and methods for forming such an electrode structure are discussed. The electrode assembly comprises a pre-coat layer compressed with a metal current collector on which a lithium-manganese rich active layer is then deposited and compressed to form the assembly. The disclosed electrode structure reduces internal resistance.

### TECHNICAL FIELD

This disclosure relates to electrode materials for lithium-ion batteries.

### BACKGROUND

Lithium-ion batteries are widely used in various applications. One of the contributors to lithium-ion battery performance is the electrode structure, which plays a role in the energy density, power density, and cycle life of the battery. Within this context, different cathode materials have been studied to maintain these properties over time. Manganese-rich cathodes have higher internal resistance compared to high nickel, nickel cobalt manganese cell formations.

### SUMMARY

In one aspect an electrode assembly comprises a current collector, and a slurry of lithium-manganese rich positive electrode active material interspersed with carbon black, carbon nanotubes, a polymeric dispersant configured to sterically repel particles of the slurry, and a binder configured to, after curing, adhere the slurry to the current collector. The average secondary particle agglomerate size of carbon black may be between 5 and 50 μm.

The carbon black in the slurry may also comprise ultra-high BET carbon black. The slurry may comprise a ratio of ultra-high BET carbon black to carbon nanotubes ranging from 2:1 to 8:1. The ultra-high BET carbon black may comprise acetylene black, furnace black, and ketjen black. The particles of acetylene black may have a surface area of 300 to 500 m²/g. The particles of ketjen black may be between 500 to 1,000 m²/g. The slurry may also further comprise single and multi-wall carbon nanotubes.

The polymeric dispersants may also comprise at least one material selected from the group consisting of polyacrylonitrile (PAV) elastomer and its copolymer, polyvinylidene fluoride (PVDF) and its modifications, poly(methyl methacrylate) (PMMA), polyacrylate and its copolymer, polyethylene oxide and its modifications, or other polymeric dispersants. The current collector may be a metal foil. The metal foil may be an aluminum foil.

In another aspect a battery comprises a current collector, an electrolyte, a separator, and an electrode with a lithium-manganese rich layer of carbon black, ultra-high BET carbon, a polymeric dispersant sterically contributing to a percolation network of the lithium-manganese rich layer, and a binder configured to adhere the layer to the current collector. The lithium-manganese rich layer of the electrode may further comprise carbon nanotubes. The lithium-manganese rich layer of the electrode may comprise a ratio of ultra-high BET carbon black to carbon nanotubes ranging from 2:1 to 8:1. The lithium-manganese rich layer of the electrode may further comprise a ratio of ultra-high BET carbon black to carbon nanotubes of 6:1.

The average secondary particle agglomerate size of carbon black may be between 5 and 50 μm. The polymeric dispersants may comprise at least one material selected from the group consisting of polyacrylonitrile (PAV) elastomer and its copolymer, polyvinylidene fluoride (PVDF) and its modifications, poly(methyl methacrylate) (PMMA), polyacrylate and its copolymer, polyethylene oxide and its modifications, or other polymeric dispersants. The ultra-high BET carbon black may further comprise acetylene black, furnace black, and ketjen black. The particles of acetylene black may have a surface area of 300 to 500 m²/g.

Another aspect discloses mixing carbon black, carbon nanotubes, a polymeric dispersant configured to sterically repel particles of a mixture, and a binder to form a slurry, applying the slurry to a current collector, and curing the slurry to the current collector.

### BRIEF DESCRIPTION OF THE DRAWINGS

FIG. 1 is a schematic cross-sectional view of an electrode assembly according to one embodiment of the disclosure;

FIG. 2 is a schematic cross-sectional view of a slurry layer according to one embodiment of the disclosure; and

FIG. 3. is a flowchart of an electrode assembly process.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Lithium manganese-rich electrodes (LMR) electrodes may have increased internal resistance when in a low state-of-charge (SOC) region, which affects cell performance and efficiency. LMR active material and carbon nanotubes (CNTs), known for their conductive properties, are utilized to form a slurry layer on a current collector. This slurry combines both carbon black, ultra-high surface carbon, carbon nanotubes, and a dispersant. The interfacial resistance of electrode assembly may be increased with the incorporation of ultra-high surface area carbon as characterized by the Brunauer, Emmett, and Teller method (BET carbon). The carbon black characterized by this method may be acetylene black, a type of carbon black. The interaction between the pre-coat and the cathode may create an interface with reduced surface charge transfer resistance. The dispersant may be a polymeric dispersant to disperse particles of the slurry in a more uniform manner providing a more even distribution of the particles. This may also lower agglomeration. The polymeric dispersants employ steric or electrostatic stabilization to help the particle remain well-dispersed within the slurry.

The combining of conductive materials, such as acetylene black and ultra-high BET carbon with CNTs, establishes a conductive layer and lowers the resistance in cathode electrodes. In one embodiment, the LMR cathode may integrate specific proportions of ultra-high BET carbon, acetylene black, dispersant, and other conductive materials to achieve increased resistance reduction. This combination may vary depending on results and production methods.

In experimental procedures a sample was prepared for comparison to a nominal LMR-cathode electrode. The specific composition of the 3.5 Ah LMR pouch cell sample was 6:1:1 of high BET carbon black, carbon nanotube, and dispersant respectively. However, the specific composition of the sample may be between 6:1:0.8 to 6:1:1.2 of high BET carbon black, carbon nanotube, and dispersant respectively. The cell formation and cycle capacity measurement test evaluate the charge capacity of the sample with the specific composition to a comparative LMR sample after electronic charge and discharge. The rate of charge or discharge current as a fraction of battery capacity or cycle capacity utilized is represented in units of capacity (C). The results in Table 1 below show the cycle capacity of the Embodiment 1 sample is increasing based on a higher C-rate capability test condition relative to Comparative sample 1.

TABLE 1
Formation and 1st cycle cell capacity
test results of 3.5Ah pouch cell

| | Comparative sample 1 | | Embodiment 1 | |
|---|---|---|---|---|
| Contents (Ave.) | Charge | Discharge | Charge | Discharge |
| 0.1 C Formation capacity | 100.0 | 100.0 | 103.3 | 102.7 |
| (%) | | | | |
| 0.1 C Cycle Capacity (%) | 100.0 | 100.0 | 102.7 | 103.0 |
| 0.3 C Cycle Capacity (%) | 100.0 | 100.0 | 105.9 | 105.9 |
| 1 C Cycle Capacity (%) | 100.0 | 100.0 | 107.6 | 108.4 |

In further experimental procedures another sample was prepared for comparison to a nominal LMR-cathode electrode. The specific composition of the 3.5 Ah LMR pouch cell sample was 6:1:1 of high BET carbon black, carbon nanotube, and dispersant respectively. However, the specific composition of the sample may be between 6:1:0.8 to 6:1:1.2 of high BET carbon black, carbon nanotube, and dispersant respectively. A cell internal resistance measurement test was conducted which measures the direct cell internal resistance (DC-IR) at a 50% state of charge (SOC). The comparative sample and embodiment were charged and discharged at 1 C, which was applied for 10 seconds and after which the internal resistance and output were measured for the samples at room temperature. The results below in Table 2 show that the DC-IR at 50% SOC is lower for the Embodiment 1 sample relative to the comparative sample LMR cell.

TABLE 2
DC-IR at 50% SOC test results of 3.5 Ah pouch cell

| | Comparative sample 1 | | Embodiment 1 | |
|---|---|---|---|---|
| Contents (Ave.) | Charge | Discharge | Charge | Discharge |
| DC-IR 50% SOC (%) | 100.0 | 100.0 | 95.2 | 94.7 |

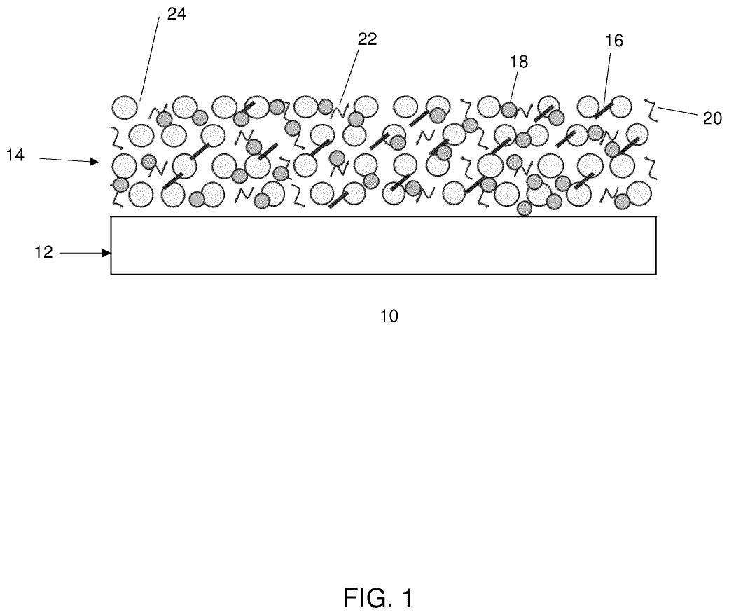

Referring now to the drawings, FIG. 1 illustrates a schematic cross-sectional view of an electrode assembly 10 according to one embodiment of the disclosure. The electrode assembly 10 has a current collector 12 and a slurry layer 14. The current collector 12 serves as a foundational layer and may be a metal current collector which may be an aluminum foil. The slurry layer 14 is deposited onto the current collector 12 and may contain carbon nanotubes 16, ultra-high surface carbon black 18, a binder 20, dispersant 22, and cathode material 24. The binder 20 which may be an acrylic acid such as modified polyvinylidene fluoride (PVDF) may also comprise a blend of polymer beads and BaTiO₃. The blending ratio of BaTiO₃ particles in the binder 20 may range from about 10% to about 80%. The cathode material 26 may be lithium-manganese rich (LMR) particles that facilitate primary electrochemical reactions. The ultra-high surface carbon black 18 and carbon nanotubes 16 of the slurry layer 14 may have a weight of between 2:1 and 8:1. In some embodiments the weight ratio of ultra-high surface carbon black 18 and carbon nanotubes 16 in the slurry layer 14 may be 6:1.

The carbon nanotubes 16 of the slurry layer 14 may comprise a mixture of single-walled carbon nanotubes (SWCNTs) and multi-walled carbon nanotubes (MWCNTs). The proportions of the mixture may be determined by the mechanical properties for the application, MWCNTs provide mechanical strength due to their multi-layered concentric cylindrical structure, while SWCNTs have higher electrical conductivity. The differing geometries and sizes between SWCNTs and MWCNTs may lead to better dispersion in the incorporated layers. Ultra-high surface carbon black 18 of the slurry layer 14, often referred to as “BET carbon,” is a form of carbon black with a large surface area. This expansive surface area is quantitatively characterized using the Brunauer, Emmett, and Teller (BET) method, a technique for measuring the surface area of porous materials. BET carbon's surface characteristics correlate to its adsorption capacity. Carbon particularly showing the BET characterized surface characteristics will be referred to as ultra-high BET carbon 18. The ultra-high BET carbon black 18 may be acetylene black, furnace black, ketjen black, or any other suitable form of carbon black. The surface area of the ultra-high BET carbon acetylene black 18 is preferably between 300 to 500 m²/g and the surface area of the ultra-high BET carbon ketjen black 18 is preferably between 500 to 1,000 m²/g.

The dispersants 22 of the slurry layer 14 may be selected a from a category of polymeric dispersants including but not limited to polyacrylonitrile (PAV) elastomer and its copolymer, polyvinylidene fluoride (PVDF) and its modifications, poly(methyl methacrylate) (PMMA), polyacrylate and its copolymer, polyethylene oxide and its modifications. The dispersants 22 play a role in the dispersion of the particles of the slurry layer 14. Specifically, the dispersants may control secondary particle agglomerate to a mean particle size of carbon black between 5 and 50 μm: Furthermore, the dispersants 22 may facilitate better contact between particles of the slurry layer 14. This may further facilitate electron transport during battery operation which may increase capacity and charge retention. Additionally, these dispersants 22 may reduce a sedimentation rate of particles of the slurry layer 14. The stabilization mechanism the dispersants 22 employ comprises mainly steric hindrance. The dispersants 22 may also employ electrostatic repulsion, solvent interactions, as well as other forces like hydrogen bonding or van der Waals forces, depending on the specific chemistry of the dispersant and the particle surface.

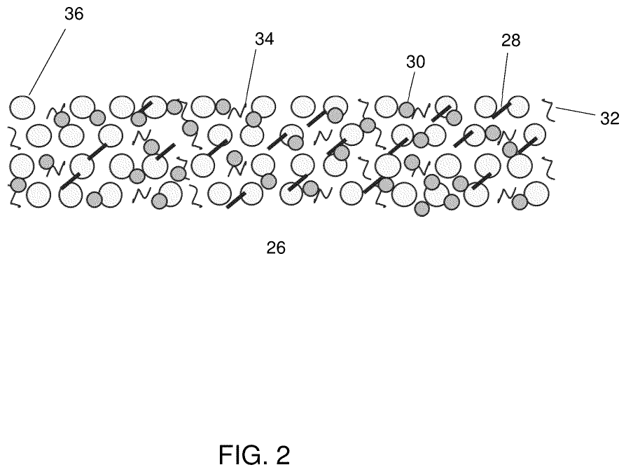

FIG. 2 depicts a schematic cross-sectional view of a slurry layer 26 comprising carbon nanotubes 28, ultra-high surface carbon black 30, a binder 32 which may be an acrylic acid such as modified PVDF, dispersant 34, and cathode material 36. The binder 32 may also comprise a blend of polymer beads and BaTiO₃. The blending ratio of BaTiO₃ particles in the binder 32 ranges from about 10% to about 80%. The cathode material 36 may be lithium-manganese rich (LMR) particles that facilitate primary electrochemical reactions. The ultra-high surface carbon black 30 and carbon nanotubes 28 of the slurry layer 26 may have a weight of between 2:1 and 8:1. In some embodiments the weight ratio of ultra-high surface carbon black 30 and carbon nanotubes 28 in the slurry layer 26 may be 6:1.

The carbon nanotubes 28 of the slurry layer 26 may comprise a mixture of SWCNTs and multi-walled carbon nanotubes MWCNTs. The proportions of the mixture may be determined by the mechanical properties for the application, MWCNTs provide mechanical strength due to their multi-layered concentric cylindrical structure, while SWCNTs have higher electrical conductivity. The differing geometries and sizes between SWCNTs and MWCNTs may lead to better dispersion in the incorporated layers. Carbon particularly showing the BET characterized surface characteristics will be referred to as ultra-high BET carbon 30. The ultra-high BET carbon black 30 may be acetylene black, furnace black, ketjen black, or any other suitable form of carbon black. The surface area of the ultra-high BET carbon acetylene black 30 is preferably between 300 to 500 m²/g and the surface area of the ultra-high BET carbon ketjen black 30 is preferably between 500 to 1,000 m²/g.

The dispersants 34 of the slurry layer 14 may be selected a from a category of polymeric dispersants 34 including but not limited to PAV elastomer and its copolymer, PVDF and its modifications, PMMA, polyacrylate and its copolymer, or polyethylene oxide and its modifications. The dispersants 34 play a role in the dispersion of the particles of the slurry layer 26. Specifically, the dispersants may control secondary particle agglomerate to a mean particle size of carbon black between 5 and 50 μm. Furthermore, the dispersants 34 may facilitate better contact between particles of the slurry layer 26. This may further facilitate electron transport during battery operation which may increase capacity and charge retention. Additionally, these dispersants 34 may reduce a sedimentation rate of particles of the slurry layer 26. The stabilization mechanisms dispersants 34 employ comprise mainly steric hindrance. The dispersants 34 also employ electrostatic repulsion, solvent interactions, and other forces like hydrogen bonding or van der Waals forces, depending on the specific chemistry of the dispersant and the particle surface.

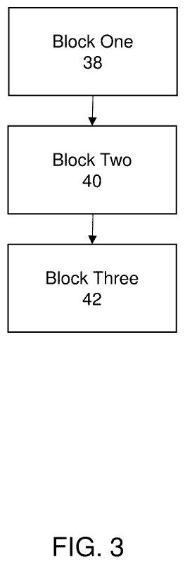

Referring now to FIG. 3, the flowchart presents a sequential process in the preparation of an electrode assembly according to an embodiment of the disclosure. The process begins with Block One 38, a slurry is prepared. This slurry is a mixture comprising carbon black, carbon nanotubes, a polymeric dispersant configured to sterically repel particles within the mixture, and a binder. In Block Two 40, the slurry is then applied directly to the current collector. In Block Three 42, the applied slurry undergoes a curing process. The curing serves to attach the slurry to the current collector, resulting in a cohesive electrode assembly.

The algorithms, methods, or processes disclosed or suggested herein may be deliverable to or implemented by a computer, controller, or processing device, which can include any dedicated electronic control unit or programmable electronic control unit. Similarly, the algorithms, methods, or processes may be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes may also be implemented in software executable objects. Alternatively, the algorithms, methods, or processes may be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electrode assembly comprising:
a current collector; and
a slurry of lithium-manganese rich positive electrode active material interspersed with carbon black, carbon nanotubes, a polymeric dispersant configured to sterically repel particles of the slurry, and a binder configured to, after curing, adhere the slurry to the current collector.

2. The electrode assembly of claim 1, wherein average secondary particle agglomerate size of the carbon black is between 5 and 50 μm.

3. The electrode assembly of claim 1, wherein the carbon black of the slurry comprises ultra-high BET carbon black.

4. The electrode assembly of claim 3, wherein the slurry comprises a ratio of ultra-high BET carbon black to carbon nanotubes ranging from 2:1 to 8:1.

5. The electrode assembly of claim 3, wherein the ultra-high BET carbon black comprises acetylene black, furnace black, and ketjen black.

6. The electrode assembly of claim 5, wherein particles of the acetylene black have a surface area of 300 to 500 m²/g.

7. The electrode assembly of claim 5, wherein particles of the ketjen black have a surface area of 500 to 1,000 m²/g.

8. The electrode assembly of claim 1, wherein the slurry comprises single and multi-wall carbon nanotubes.

9. The electrode assembly of claim 1, wherein the polymeric dispersants comprise at least one material selected from the group consisting of polyacrylonitrile (PAV) elastomer and its copolymer, polyvinylidene fluoride (PVDF) and its modifications, poly(methyl methacrylate) (PMMA), polyacrylate and its copolymer, polyethylene oxide and its modifications, or other polymeric dispersants.

10. The electrode assembly of claim 1, wherein the current collector is a metal foil.

11. The electrode assembly of claim 10, wherein the metal foil is an aluminum foil.

12. A battery comprising:
a current collector; and
an electrode with a lithium-manganese rich layer of carbon black, ultra-high BET carbon, a polymeric dispersant sterically contributing to a percolation network of the lithium-manganese rich layer, and a binder configured to adhere the layer to the current collector.

13. The battery of claim 12, wherein the lithium-manganese rich layer of the electrode further comprises carbon nanotubes.

14. The battery of claim 13, wherein the lithium-manganese rich layer of the electrode comprises a ratio of ultra-high BET carbon black to carbon nanotubes ranging from 2:1 to 8:1.

15. The battery of claim 14, wherein the lithium-manganese rich layer of the electrode comprises a ratio of ultra-high BET carbon black to carbon nanotubes of 6:1.

16. The battery of claim 12, wherein average secondary particle agglomerate size of carbon black is between 5 and 50 μm.

17. The battery of claim 12, wherein the polymeric dispersants comprise at least one material selected from the group consisting of polyacrylonitrile (PAV) elastomer and its copolymer, polyvinylidene fluoride (PVDF) and its modifications, poly(methyl methacrylate) (PMMA), polyacrylate and its copolymer, polyethylene oxide and its modifications, or other polymeric dispersants.

18. The battery of claim 12, wherein ultra-high BET carbon black comprises acetylene black, furnace black, and ketjen black.

19. The battery of claim 18, wherein particles of the acetylene black have a surface area of 300 to 500 m²/g.

20. A method comprising:
mixing carbon black, carbon nanotubes, a polymeric dispersant configured to sterically repel particles of a mixture, and a binder to form a slurry;
applying the slurry to a current collector; and
curing the slurry to the current collector.
